(19) United States
(12) Patent Application Publication
(10) Pub. No.: US 2018/0116378 A1
(43) Pub. Date: May 3, 2018

(54) Receiving Clamp for a Power Tool; Arrangement of Carrying System for a Power Tool and Receiving Clamp; and Arrangement of Carrying System, Receiving Clamp, and Power Tool

(71) Applicant: Andreas Stihl AG & Co. KG, Waiblingen (DE)

(72) Inventors: Patrick Schindler, Remshalden (DE); Daniel Sasse, Stuttgart (DE); Christian Bareiß, Alfdorf-Pfahlbronn (DE); Jan Föhrenbach, Fellbach (DE); Stephan Hess, Basel (CH)

(21) Appl. No.: 15/702,892

(22) Filed: Sep. 13, 2017

(30) Foreign Application Priority Data
Oct. 31, 2016 (DE) 10 2016 013 145.4

(51) Int. Cl. A45F 3/14

(52) U.S. Cl. CPC A45F 3/14; A01G 3/086

(57) ABSTRACT

A receiving clamp for a power tool has a clamp body with first and second end faces and a receptacle extending from the first to the second end face. The receptacle is provided to receive a guide rod of the power tool. The receptacle has a longitudinal center axis and a slot extending from the first to the second end face. The slot is open across its entire length relative to the environment. The clamp body has bending elasticity in a direction transverse to the slot so that the slot can be widened. A suspending location is arranged on the clamp body and connectable to a carrying system for the power tool. The suspending location is arranged such that, when the receiving clamp is suspended by the suspending location and the longitudinal center axis is positioned in a horizontal plane, the slot is lower than the suspending location.

### BACKGROUND OF THE INVENTION

The invention relates to a receiving clamp for a power tool; an arrangement of a carrying system for a power tool and a receiving clamp; and an arrangement of a carrying system, a receiving clamp, and a power tool.

US 2006/0179806 discloses a carrying system for a power tool with a support arm. The support arm is provided with a receptacle in which a guide rod of the power tool is secured. The receptacle surrounds a shaft of the guide rod and secures the shaft in longitudinal direction by clamping forces. Due to the elastic configuration of the receptacle, the guide rod can be displaced in the receptacle, if needed.

The option of a fast and simple detachment of the power tool from the carrying system as a quick release action is desirable for power tools that are secured on carrying systems. Such a release system is disclosed in U.S. Pat. No. 8,857,682. On the guide rod, a fixed clamp is provided that is suspended from a hook of the carrying system. For a quick release action, it is necessary to separate the hook with the clamp suspended therefrom and the guide rod from the carrying system. The connection of the guide rod with the carrying system is therefore complex and comprised of many individual parts.

The invention has the object to provide a receiving clamp that enables a simple configuration of a device for quick release of a power tool from a carrying system. A further object of the invention resides in providing an arrangement of carrying system and receiving clamp which has a simple configuration and enables a quick release of a power tool from the carrying system. A further object of the invention resides in providing an arrangement of a carrying system, a receiving clamp, and a power tool which has a simple configuration and enables a quick release of the power tool from the carrying system.

### SUMMARY OF THE INVENTION

In accordance with the invention, this is achieved in regard to the receiving clamp by a receiving clamp for a power tool wherein the receiving clamp comprises a first end face, a second end face, and a receptacle, extending from the first end face to the second end face, for receiving a guide rod of a power tool, wherein the receptacle comprises a longitudinal center axis and a slot which extends from the first end face to the second end face, wherein the receiving clamp is designed to have bending elasticity in a direction transverse to the slot so that the slot can be widened, and wherein the receiving clamp comprises at least one suspending or hooking location for connection with a carrying system for the power tool, wherein the slot across its entire length from the first end face to the second end face is open relative to the environment and the at least one suspending or hooking location is arranged such on the receiving clamp that, when the receiving clamp is suspended by the at least one suspending location and the longitudinal center axis is positioned in a horizontal plane, the slot is arranged lower than the suspending location.

In regard to the arrangement of the carrying system and of the receiving clamp, the object is solved by an arrangement of a carrying system for a power tool and a receiving clamp for a power tool, wherein the receiving clamp comprises a first end face, a second end face, and a receptacle, extending from the first end face to the second end face, for receiving a guide rod of a power tool, wherein the receptacle comprises a longitudinal center axis and a slot which extends from the first end face to the second end face, wherein the receiving clamp is designed to have bending elasticity in a direction transverse to the slot so that the slot can be widened, and wherein the receiving clamp comprises at least one suspending or hooking location for connection with a carrying system for the power tool, wherein the slot across its entire length from the first end face to the second end face is open relative to the environment and the at least one suspending or hooking location is arranged such on the receiving clamp that, when the receiving clamp is suspended by the at least one suspending location and the longitudinal center axis is positioned in a horizontal plane, the slot is arranged lower than the suspending location, wherein the carrying system comprises a support arm on which the receiving clamp is arranged, wherein the receiving clamp is secured by the suspending location on the carrying system, wherein the slot, in an operating position of the carrying system in which the receiving clamp is suspended from the carrying system, is at least partially downwardly oriented.

In regard to the arrangement of a carrying system, a receiving clamp, and a power tool, the object is solved by an arrangement of a carrying system, a receiving clamp, and a power tool, wherein the receiving clamp comprises a first end face, a second end face, and a receptacle, extending from the first end face to the second end face, for receiving a guide rod of the power tool, wherein the receptacle comprises a longitudinal center axis and a slot extending from the first end face to the second end face, wherein the receiving clamp is designed to have bending elasticity in a direction transverse to the slot so that the slot can be widened, and wherein the receiving clamp comprises at least one suspending or hooking location for connection with the carrying system for the power tool, wherein the slot across its entire length from the first end face to the second end face is open relative to the environment and the at least one suspending or hooking location is arranged such on the receiving clamp that, when the receiving clamp is suspended by the at least one suspending or hooking location and the longitudinal center axis is positioned in a horizontal plane, the slot is arranged lower than the suspending location, wherein the power tool comprises a guide rod held in the receiving clamp, and wherein the slot in an operating position of the guide rod in which the power tool is suspended from the carrying system and secured by means of the receiving clamp on the carrying system, is at least partially downwardly oriented.

The receiving clamp according to the invention comprises a receptacle that is open relative the environment by means of a slot extending from the first end face to the second end face. Accordingly, the slot is not bridged by parts of the receiving clamp or other elements but forms across its entire length a free passage to the environment. The slot must not extend straight but can be slanted, have an arc shape, have a meandering shape or the like. The receiving clamp is embodied to have bending elasticity transverse to the length extension of the slot so that the slot can be widened. In this way, the guide rod by widening the slot can be simply pushed into the receiving clamp or can be pushed out of the receiving clamp. When the receiving clamp is secured to be freely rotatable at the at least one suspending location and the longitudinal center axis of the receiving clamp is positioned in a horizontal plane, the slot is lower than at least one, in particular lower than all, suspending locations. Only the weight of the receiving clamp is acting on the receiving clamp. In this way, the operator can push the guide rod out of the receiving clamp by an intuitive movement oriented away from the operator's body. Pushing out the guide rod from the receiving clamp as an intuitively performable quick release action makes it easy for the operator to release the guide rod quickly from the carrying system in exceptional situations. The quick release is integrated in the receiving clamp. In this way, additional devices which are known in connection with quick release action are not required. For the quick release action no additional components are required. The quick release action is enabled by the configuration of the receiving clamp itself, i.e., by the slot which is open toward the environment and which can be widened. Accordingly, for the operator mounting of the guide rod on the receiving clamp as well as on the carrying system is facilitated.

When the receiving clamp is in a position of rest in which the receiving clamp is placed on a horizontal and flat support surface and the slot is oriented toward the support surface, the at least one suspending location is advantageously arranged above the receptacle. With this arrangement of the at least one, in particular all, suspending locations and of the slot, it can be ensured in a simple way that the receiving clamp will be oriented such that the slot is arranged lower than the at least one, in particular all, suspending locations.

The connection of the receiving clamp with the carrying system is realized advantageously by means of a limp or flexible connecting element. A limp or flexibly connecting element is a connecting element that transmits exclusively tensile forces. The connecting element is advantageously fastened to the at least one suspending location of the receiving clamp. The at least one suspending location is advantageously integrally formed in the shape-stable material of the receiving clamp. The suspending location comprises advantageously a defined position relative to the receptacle and the slot. Relative to the receptacle, the suspending location and the slot are arranged opposite each other on the receiving clamp so that a force exerted on the guide rod in the direction of the slot at least partially is introduced as a tensile force into the connecting element. In this way, an intuitive emergency release by pushing away the guide rod is realizable.

Advantageously, the bending elasticity of the receiving clamp is oriented so as to counteract widening of the slot. The receiving clamp is advantageously designed such that for widening the slot a force of at least 200 N, in particular at least 400 N, is required. Due to the minimum spring force which is counteracting the widening of the slot, the guide rod is securely fixed in the receiving clamp in regard to forces that are acting on the guide rod in operation so that an accidental displacement of the guide rod in the receiving clamp or pushing out of the guide rod from the receiving clamp can be avoided. The spring force is at the same time selected such that the operator, by forcefully pushing against the guide rod, can overcome the spring force in order to achieve quick release action of the power tool from the receiving clamp.

Advantageously, insertion elements are arranged at the receptacle that extend at least partially along the slot for threading a guide rod of the power tool. For mounting, the receiving clamp can be positioned with the insertion elements on the guide rod and the receiving clamp can be subsequently pushed onto the guide rod. After overcoming the spring force which counteracts the widening of the slot, the guide rod snaps into the receptacle. In this way, mounting of the guide rod in the receiving clamp is easily possible. In a particularly advantageous embodiment, the insertion elements each comprise a support edge extending parallel to the longitudinal center axis for resting the receiving clamp on a support surface.

Expediently, the receptacle has a length measured parallel to the longitudinal center axis and a smallest inner diameter which is measured perpendicular to the longitudinal center axis, wherein the length is greater than the smallest inner diameter. In this way, a good guiding action for sliding displacement of the receiving clamp is achieved and tilting of the receiving clamp relative to the guide rod is substantially avoided so that a good fixation of the receiving clamp on the guide rod results. Advantageously, clamping ribs are arranged on an inner surface of the receptacle and extend in circumferential direction. The clamping ribs serve in particular for increasing the surface pressure. Even for soiled guide rods, by means of the clamping ribs a good contact between the receiving clamp and the guide rod is possible because dirt or the like is displaced into the interstices between the clamping ribs. The spring force which is provided by the receiving clamp can be transmitted by means of the clamping ribs in a targeted fashion onto the guide rod.

Advantageously, between the surfaces that delimit the receptacle for the guide rod and the guide rod a no-slip material is arranged. This can be advantageously a rubber sheath arranged on the guide rod. Alternatively, a rubber component can be injection molded onto the receiving clamp, at least to the surfaces that delimit the receptacle, or a rubber member can be placed into the receiving clamp.

It is advantageously provided that the receiving clamp comprises two rigid receiving elements and at least one spring element. Particularly advantageously, the receiving elements are connected by a joint to each other wherein the two receiving elements in particular are braced against each other by means of the at least one spring element. Advantageously, the two rigid receiving elements and the spring element can be embodied separate from each other. In a preferred embodiment, the joint can be integrated into the receiving elements. In this way, mounting of the receiving clamp is simplified. The joint comprises in particular at least one joint head which is integrally formed on one of the receiving elements and is projecting into a joint socket on the other receiving element so as to form together the joint. However, it can also be provided that two rigid receiving elements are formed as one piece and, for example, are connected by a spring element or by a joint that is formed together with the receiving elements as one piece, for example, by an integrally molded-on rubber joint.

Advantageously, the at least one spring element extends about a wrap angle that is measured relative to the longitudinal center axis and amounts to at least 200°, in particular 200° to 330°, preferably 230° to 290°. The spring element must not be contacting the receiving elements about the entire wrap angle but, across sections thereof, can be positioned at a spacing to the receiving elements.

The spacing of a spring element, measured in the direction of the longitudinal center axis, relative to a suspending location corresponds advantageously to at least 0.5 times the amount of the smallest inner diameter. Advantageously, at least two spring elements are provided which, relative to the longitudinal center axis, are arranged on opposite sides of the suspending location. In particular, both spring elements have the same spacing relative to the suspending location. In an advantageous configuration, the spring elements are arranged near the end faces of the receiving clamp. The spacing of the spring element relative to an end face is advantageously smaller than 0.2 times, in particular 0.1 times, the amount of the smallest inner diameter.

It is provided that the receiving clamp comprises an actuating device for widening the slot. The actuating device enables the operator to widen the slot against the acting spring force so that the receiving clamp can be fixed on the guide rod or can be released therefrom. Advantageously, upon widening the slot, the receptacle is also widened so that the actuating device can be utilized to reduce the clamping force of the receiving clamp on the guide rod and to thereby reduce or cancel the contact between receiving clamp and guide rod so that the receiving clamp can be displaced along the guide rod. It is therefore possible for the operator to displace or slide the guide rod in the receiving clamp in a simple way and to adapt their arrangement relative to each other to a respective working position. The actuating device is advantageously formed by two projections, each arranged on one of the receiving elements, and the projections are to be pushed toward each other for widening the slot.

Advantageously, the width of the slot at every slot location is at least 10 mm, in particular at least 20 mm, preferably at least 30 mm. By the minimum width of the slot it is ensured that solely by pushing away the guide rod from the carrying system a sufficiently large force for widening the slot can be applied. In preferred configuration, the width of the slot is constant across at least 50% of the length of the receiving clamp, in particular across the entire length of the slot from one end face to the other end face of the receiving clamp.

For an arrangement of a carrying system for a power tool and a receiving clamp, wherein the carrying system comprises a support arm on which the receiving clamp is arranged, wherein the receiving clamp by the at least one suspending location is secured on the carrying system, it is provided that the slot is pointing at least partially downwardly in an operating position of the carrying system in which the receiving clamp is suspended from the carrying system.

The receiving clamp is advantageously connected by a connecting element with the carrying system. The connecting element is advantageously fastened to the at least one suspending location on the receiving clamp. The connecting element and the slot are advantageously arranged on opposite sides of the receptacle. With the guide rod suspended from the carrying system, the connecting element is advantageously arranged above the guide rod and the slot below the guide rod. No connecting element is extending below the guide rod. In particular, the slot is not bridged by a connecting element.

In this way, it is possible for the operator, by an intuitive movement in downward direction and/or away from the operator's body or from the carrying system, to push the guide rod out of the receiving clamp. The action of pushing the guide rod out of the receiving clamp as an intuitively performable quick release action makes it easy for the operator to release or detach the guide rod quickly from the carrying system in exceptional situations.

For the arrangement of a carrying system, a receiving clamp, and a power tool, wherein the power tool comprises a guide rod secured in the receiving clamp, it is provided that the slot is pointing at least partially downwardly in an operating position of the guide rod in which the power tool is suspended from the carrying system and is secured by means of the receiving clamp on the carrying system.

With this arrangement of carrying system, receiving clamp, and power tool, ergonomic working is possible. In particular in case of working above one's head, a force-saving work is possible due to the carrying system. In an operating position of the guide rod in which the slot of the receiving clamp is at least partially facing downwardly, the operator by an intuitive movement in downward direction and/or away from the operator's body, can push the guide rod out of the receiving clamp. In this situation, the operator must not actuate the receiving clamp. For release of the guide rod from the receiving clamp, the operator can keep his hands on the power tool, in particular on the guide rod, and must only apply a force on the receiving clamp by means of the power tool. Pushing the guide rod out of the receiving clamp as an intuitively performable quick release action makes it easy for the operator to release the guide rod quickly from the carrying system in exceptional situations.

Advantageously, the guide rod is secured in the receiving clamp by means of the spring force. Accordingly, the guide rod is fixedly secured in the receiving clamp against forces acting on the guide rod in operation so that accidentally displacing the guide rod in the receiving clamp or accidentally pushing the guide rod out of the receiving clamp is prevented. It is particularly advantageous that the spring force can be at least partially canceled upon actuation of an actuating device so that the power tool is movable or slidable in the direction of the longitudinal center axis within the receiving clamp. With the partial cancellation of the clamping action resulting from the spring force, the receiving clamp can be moved in a particularly simple way along the guide rod. In this way, the arrangement between power tool and carrying system can be adapted to a desired operating position by means of the displacement of the receiving clamp relative to the guide rod.

### BRIEF DESCRIPTION OF THE DRAWING

FIG. 1 is a schematic perspective illustration of an operator with a carrying system on which a power tool is arranged.

FIG. 2 is a perspective illustration of an arrangement of a guide rod of a power tool provided with a tool member in a receiving clamp on a carrying system.

FIG. 3 is a perspective detail illustration of an arrangement of a guide rod of a power tool in a receiving clamp.

FIG. 4 is a perspective illustration of the receiving clamp.

FIG. 5 is a perspective illustration of the receiving clamp in actuated spread-apart state without spring elements.

FIG. 6 is a side view of the receiving clamp of FIG. 5.

FIG. 7 is a front view of the receiving clamp in the direction of arrow VII of FIG. 6.

FIG. 8 is a front view of the receiving clamp in the direction of arrow VII of FIG. 6 in the spread-apart state without spring elements.

FIG. 9 is a plan view of the receiving clamp in the direction of arrow IX of FIG. 6.

FIG. 10 is a plan view of the receiving clamp in the direction of arrow IX of FIG. 6 in the spread-apart state without spring elements.

FIG. 11 is a plan view of the receiving clamp in a view from below in the direction of arrow XI of FIG. 6.

FIG. 12 is a perspective illustration of a receiving element of the receiving clamp.

FIG. 13 is a side view of the receiving element of FIG. 12.

FIG. 14 is a side view of the receiving element in the direction of arrow XIV of FIG. 13.

FIG. 15 is a side view of the receiving element in the direction of arrow XV of FIG. 13.

FIG. 16 is a side view of the receiving element in the direction of arrow XVI of FIG. 13.

FIG. 17 is a side view of the receiving element in the direction of arrow XVII of FIG. 13.

FIG. 18 is a side view of the receiving element in the direction of arrow XVIII of FIG. 14.

FIG. 19 is a front view of the receiving clamp with an embodiment of a guide rod arranged therein.

### DESCRIPTION OF PREFERRED EMBODIMENTS

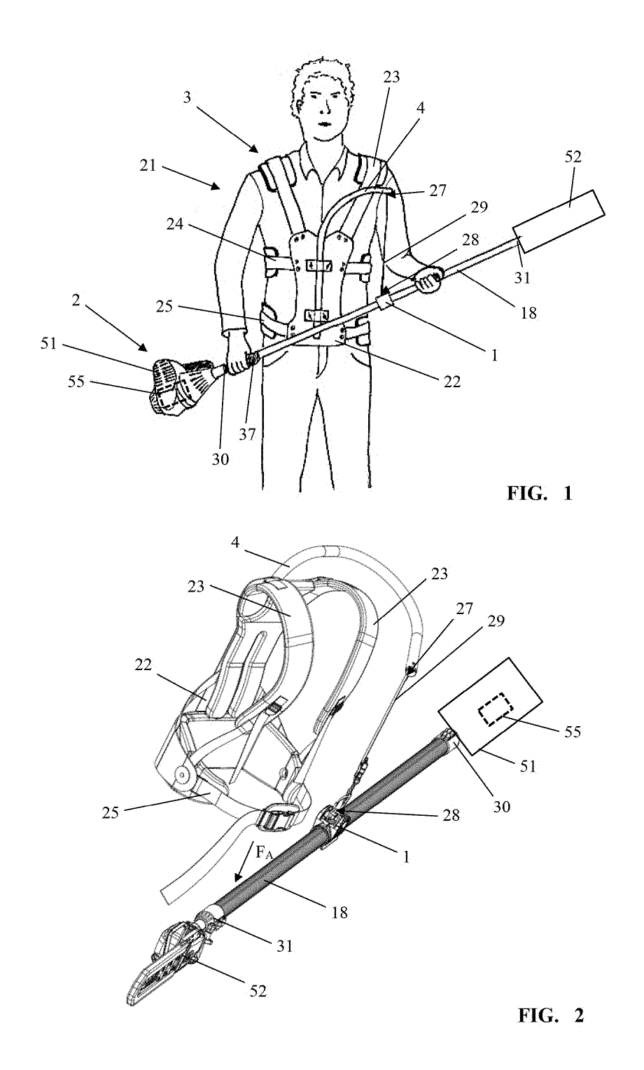

In FIG. 1, an operator 21 is shown who employs a carrying system 3 on which a power tool 2 with a guide rod 18 is arranged. The power tool 2 can be, for example, a pole pruner, a trimmer or another portable power tool 2 with a guide rod 18. The carrying system 3 is configured for at least partial absorption of the weight of the power tool 2 by the shoulders and/or the trunk and/or the hips of the operator 21. The carrying system 3 comprises advantageously a support plate 22 which is carried by the operator 21 by means of a hip belt 25, a back strap 24, and two shoulder straps 23. The support arm 4 is attached to the support plate 22. The support arm 4 projects, relative to the operator 21, in upward direction and in the direction toward the guide rod 18 of the power tool 2. On the projecting end of the support arm 4, a first end 27 of a connecting element 29 is attached in the embodiment. The connecting element 29 is in particular limp or flexible. In the embodiment, the connecting element 29 is a connecting cord. The connecting element 29 can be comprised of several sections that are connected to each other. At the second end 28 of the connecting element 29, a receiving clamp 1 is attached. The receiving clamp 1 is therefore suspended from the carrying system 3. Any other type of configuration of a carrying system 3 can be advantageous also.

In FIG. 2, an alternative carrying system 3 is illustrated on which the power tool 2 is arranged. The carrying system 3 comprises in the embodiment a carrying plate 22 which is carried by the operator 21 by means of a hip belt 25 and two shoulder straps 23. A support arm 4 is attached to the support plate 22 and is extending upwardly and forwardly relative to the operator 21 in the direction of the guide rod 18; in the embodiment, the support arm 4 extends across the shoulder of the operator 21.

Alternatively, the carrying system 3 can comprise a belt in the form of a loop which is placed about the shoulder and the trunk of the operator 21 and a limp or flexible connecting element 29 which connects the belt with the receiving clamp 1. It can also be provided that the connecting element 29 is secured immediately on the operator 21. Other configurations of the carrying system 3 can also be advantageous.

The arrangements of carrying system 3, receiving clamp 1, and power tool 2 illustrated in FIG. 1 and in FIG. 2 are designed to enable ergonomic work for extended periods of time. The power tool 2 comprises a guide rod 18 which is secured in the receiving clamp 1. As shown in the schematic section illustration of FIG. 19, the guide rod 18 has a non-round cross section. In the embodiment, the guide rod 18 comprises a guide tube 61 that is covered by a sheath 32, in the embodiment a profiled rubber coating. The cross section of the guide rod 18 is approximately a square cross section with rounded corners.

As shown in FIG. 1 and in FIG. 2, the guide rod 18 has two ends 30, 31, wherein on one end 30 a housing 51 is arranged which is schematically shown in FIG. 2. At the second end 31 of the guide rod 18, a tool member 52 is arranged which is shown only schematically in FIG. 1. The tool member 52 can be, for example, a saw chain driven in circulation about a guide bar. The tool member 52 is driven advantageously by a drive motor 55, arranged in the housing 51, by means of a drive shaft supported in the guide rod 18. The drive motor 55 is in particular an internal combustion engine. However, it can also be advantageous that the drive motor 55 is designed as an electric motor. The drive motor 55 is then advantageously arranged at the second end 31 of the guide rod 18 and is supplied with electric power by cables guided in the guide rod 18. In the housing 51, a battery pack can be arranged advantageously as a power supply. The power tool 2 comprises a grip 37, only shown in FIG. 1, which is advantageously arranged adjacent to the housing 51 and by means of which the operator 21 can guide the power tool 2. The other hand of the operator 21 grips advantageously the guide rod 18. Alternatively, a further grip or handle can be provided on the guide rod 18. Advantageously, operating elements, not illustrated, for the drive motor 55 are arranged on the grip 37.

The receiving clamp 1 enables a quick release action of the guide rod 18 from the receiving clamp 1. When a release force F_{A}, for example, exerted by the operator 21 or by a branch that is dropping onto the guide rod 18, is acting on the guide rod 18, this release force F_{A}—when it is sufficiently great—can effect release of the guide rod 18 from the receiving clamp 1; this will be explained in more detail in the following.

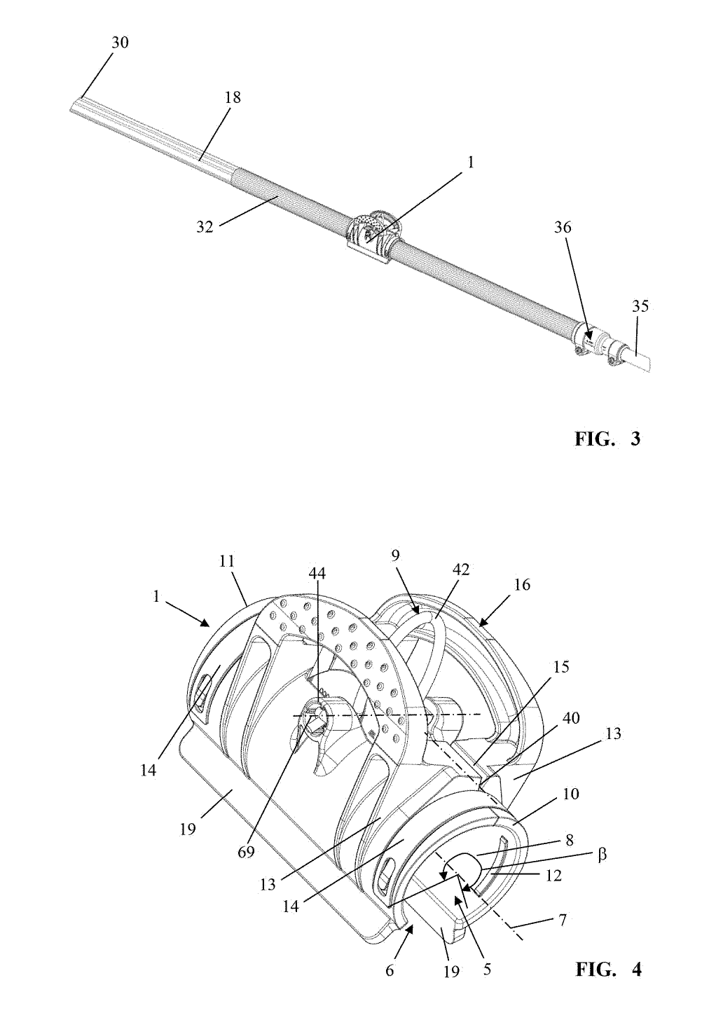

FIG. 3 shows in perspective view the arrangement of the guide rod 18 and of the receiving clamp 1. In the embodiment, a sheath 32 is arranged on the guide rod 18 that is profiled in longitudinal direction of the guide rod 18 and is designed as a grip area. The receiving clamp 1 in the embodiment is arranged on the sheath 32 on the guide rod 18. The receiving clamp 1 can be arranged in different positions on the guide rod 18, preferably on the sheath 32, for adaptation to the personal working position of the operator 21 or to the work task at hand, for example, working at different working levels or with different tool members 52. In the embodiment, the guide rod 18 comprises a telescoping rod 35 which, for adjusting the length of the guide rod 18, can be secured by a telescoping device 36 in different positions. For an optimal assistance by the carrying system 3, the connection of the power tool 2 to the carrying system 3 should be approximately at the center of gravity. Depending on the selected length of the guide rod 18 and/or of the employed tool member 52, the position of the receiving clamp 1 on the guide rod 18 can be changed accordingly.

In FIG. 4, the receiving clamp 1 is illustrated in perspective view. The clamp body of the receiving clamp 1 comprises a receptacle 5 in which the guide rod 18 can be arranged. The receptacle 5 comprises a longitudinal center axis 7. The longitudinal center axis 7 of the receptacle 5 is positioned parallel, in particular coaxial, to a longitudinal center axis of a guide rod 18 which is arranged in the receptacle 5. In the embodiment, the cross section of the receptacle 5 in a plane that is perpendicular to the longitudinal center axis 7 is approximately circular. The clamp body of the receiving clamp 1 comprises a first end face 10 and a second end face 11. The end faces 10, 11 are the sides which delimit the receiving clamp 1 in longitudinal direction. In the embodiment, the end faces 10, 11 are positioned approximately perpendicular to the longitudinal center axis 7 of the receptacle 5. The receptacle 5 extends from the first end face 10 to the second end face 11. The receptacle 5 is open relative to the environment by means of the slot 6 extending from the first end face 10 to the second end face 11. At each cross section of the receptacle 5, the receiving clamp 1 comprises an immediate connection between the receptacle 5 and the environment via the slot 6. In the embodiment, the slot 6 extends parallel and at a spacing to the longitudinal center axis 7. The slot 6 is not bridged so that the guide rod 18, for release from the carrying system 3, can be pushed out of the receiving clamp 1 through the slot 6. The receiving clamp 1 comprises clamping ribs 12 which are arranged on the inner surface of the receptacle 5. The clamping ribs 12 provided in the receptacle 5 extend preferably in circumferential direction of the receptacle 5 and in operation, with the guide rod 18 arranged in the receiving clamp 1, are in contact with the exterior surface of the guide rod 18.

As shown in FIG. 4, the receiving clamp 1 in the embodiment is comprised of two individual receiving elements 13 and two spring elements 14. Further elements are not required for the receiving clamp 1. The receiving elements 13 are substantially rigid. In the embodiment, when opening the receiving clamp 1, the spring elements 14 are deformed and the receiving elements 13 pivoted relative to each other to thereby widen the slot 6. A minimal deformation of the receiving elements 13 can however be provided. Advantageously, insertion elements 19 that are extending at least partially alongside the slot 6 are provided at the receptacle 5 for threading the guide rod 18 of the power tool 2 into the receptacle 5. On the receiving clamp 1, an actuating device 16 is arranged; by manually actuating the actuating device 16, the operator 21 (FIG. 1) can widen the slot 6.

The receiving elements 13 are connected pivotably to each other. On the receiving elements 13 at least one joint 15 is arranged by means of which the receiving elements 13 can be aligned to each other and/or connected to each other. In the embodiment, two joints 15 are provided, as shown also in FIG. 5. As shown in FIG. 4 and FIG. 5, the joints 15 have a common joint axis 40 which in the embodiment extends parallel to the longitudinal center axis 7. The two receiving elements 13 can be pivoted relative to each other about the pivot axis 40 of the joint 15.

Advantageously, for each joint 15, a joint half is formed integrally on each receiving element 13. Advantageously, a plurality of joints 15 are provided, in the embodiment two joints 15, wherein the joint halves which are arranged and preferably integrally formed on one receiving element 13 have a different configuration. This enables the configuration of the receiving elements 13 as identical parts. In this way, manufacture and assembly of the receiving clamp 1 is simplified.

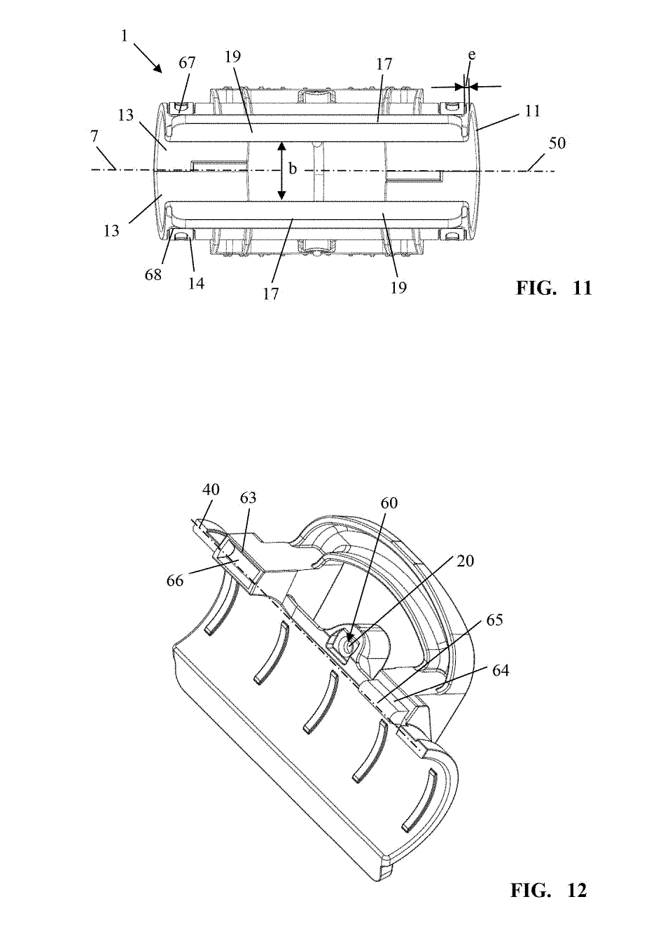

The spring elements 14 engage across the receiving elements 13 and brace the receiving elements 13 against each other. In this way, the receiving clamp 1 is designed to have bending elasticity. The at least one spring element 14 holds together the at least one joint 15. The receiving elements 13 are secured relative to each other by the at least one spring element 14. The spring elements 14 are advantageously arranged adjacent to the end faces 10 and 11. The spring elements 14 extend advantageously about the outer circumference of the receptacle 5 on the receiving clamp 1. The spring elements 14 wrap around the receiving clamp 1 in the non-actuated state of the receiving clamp 1 by a wrap angle β which is illustrated schematically in FIG. 4. The wrap angle β is measured about the longitudinal center axis 7 from one end 67 of the spring element 14 to the other end 68 (FIG. 11) of the spring element 14. The wrap angle β amounts advantageously to at least 200°, in particular 200° to 330°. In the embodiment, a wrap angle of 230° to 290° is provided.

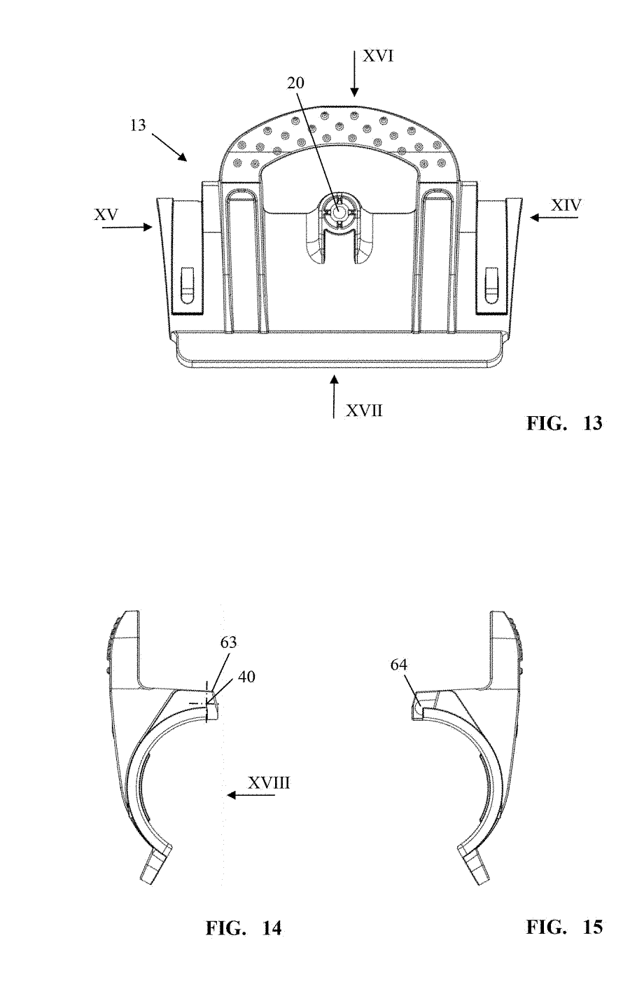

The connecting element 29 comprises a cord 42 which is fastened on the receiving clamp 1; in the embodiment, each end is connected to one receiving element 13, respectively. In FIGS. 12 and 13, the suspending location 20 is illustrated where the cord 42 of the connecting element 29 is secured on the receiving clamp 13. The receiving clamp 1 is suspended from the carrying system 3 by means of the connecting element 29. In this context, the receiving clamp 1 is fastened to the second end 28 of the connecting element 29 of the carrying system 3 (FIG. 1) by means of the connecting element 29 that is fastened to the at least one suspending location 20 to the receiving clamp 1.

In an embodiment that is not illustrated, the receiving elements 13 are connected by a material joint instead of a mechanical joint 15. The receiving elements 13 are connected by material fusion with each other at the material joint. The material joint is a joint that as a result of its material and/or its shape is in itself provided with bending elasticity so that the slot 6 by elastic deformation of the joint 15 can be widened sufficiently. For increasing the bending stiffness, the receiving clamp 1 can comprise one or several spring elements 14.

FIG. 5 shows the receiving clamp 1 in the spread-apart state. The spring elements 14 are not shown in FIG. 5. The receiving elements 13 comprise grooves 45 which extend in circumferential direction of the receptacle 5 adjacent to the end faces 10 and 11 and serve for receiving the spring elements 14. Due to the pivot movement of the receiving elements 13 relative to each other, the spring elements 14 are lifted off the receiving elements 13 adjacent to the joint axis 14 when the receiving clamp 1 is opened.

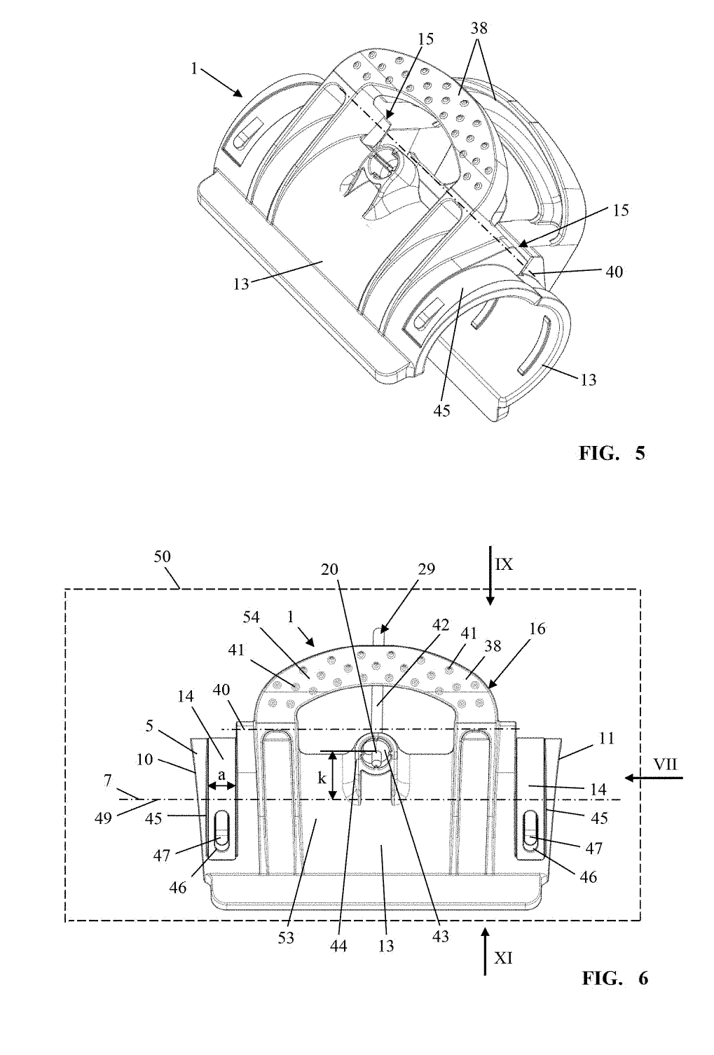

In FIG. 6, a side view of the receiving clamp 1 is illustrated. The receiving clamp 1 comprises two suspending locations 20 of which in FIG. 6 one is visible. When the receiving clamp 1 is held by the at least one suspending location 20 and when exclusively the weight of the receiving clamp 1 is acting as a force, the longitudinal center axis 7 of the receptacle 5 is in a horizontal plane 49 and the joint axis 40 defines together with the longitudinal center axis 7 of the receptacle 5 a vertical plane 50 which is oriented perpendicular to the horizontal plane 49. In the embodiment, the vertical plane 50 is a plane which contains the longitudinal center axis 7 and extends through the middle of the slot 6. In a state in which the receiving clamp 1 is held by the suspending location 20, the slot 6 is located lower than the suspending location 20. When the receiving clamp 1 is connected to the carrying system 3 by the connecting element 29 engaging the suspending locations 20, the receiving clamp 1 is suspended from the carrying system 3 such that the slot 6 is facing the ground and is facing away from the connecting element 29. The slot 6 and the suspending locations 20 are positioned on opposite sides of the receptacle 5. In this context, it is not required that the slot 6 and the suspending locations 20 are positioned diametrically opposite each other relative to the longitudinal center axis 7. Advantageously, the slot 6 and the suspending locations 20 are positioned on opposite sides of the horizontal plane 49.

The longitudinal center axis 7 of the receptacle 5 and the joint axis 40 define a first plane which extends through the slot 6 and coincides in the illustrated position of the receiving clamp 1 of the embodiment with the vertical plane 50. A second plane, which contains the longitudinal center axis 7 and is positioned perpendicular to the first plane, divides the receiving clamp 1 into an upper half and a lower half. In the illustrated position of the receiving clamp 1 of the embodiment, the second plane coincides with the horizontal plane 49. The actuating device 16 and the at least one suspending location 20 are positioned in the upper half of the receiving clamp 1 and the slot 6 is positioned in the lower half of the receiving clamp 1.

The receiving clamp 1 comprises in the embodiment at least two lugs 44 where the suspending locations 20 are formed. When a plurality of suspending locations 20 are provided, they are positioned advantageously symmetrically to the first plane, in particular to the vertical plane 50. As shown in FIGS. 12 and 13, the lugs 44 each have an opening 60 through which the connecting element 29, in particular the cord 42, is passed. The geometric center point on the inner side of the opening 60 is viewed as suspending location 20.

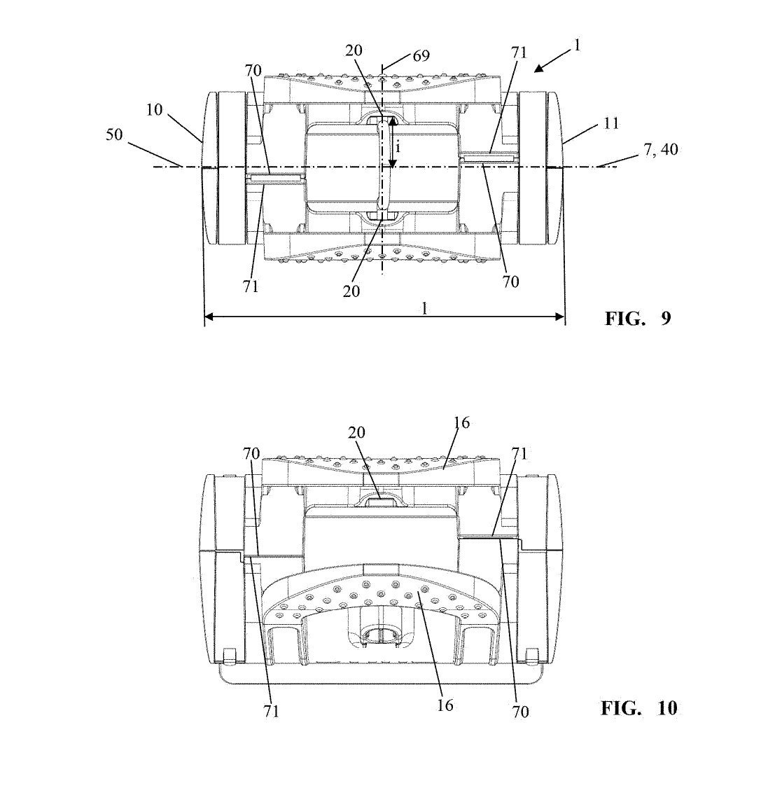

The two lugs 44 are arranged on an external surface 53 of the receiving clamp 1, in the embodiment on a respective receiving element 13, as shown in FIG. 6. In the embodiment, the two lugs 44 comprise a spacing i relative to the joint axis 40 which is illustrated in FIG. 9. When the receiving clamp 1 is suspended from the carrying system 3, the joint axis 40 in the embodiment is arranged above and between the suspending locations 20. The spacing i represents a lever arm which enhances the opening movement of the receiving clamp 1. The greater the spacing i, the smaller the required release force F_{A} for the same strength of the spring elements 14.

In a state of the receiving clamp 1 suspended from the suspending location 20, the lugs 44 are preferably positioned opposite each other relative to the vertical plane 50 and are arranged above the longitudinal center axis 7 of the receptacle 5. In the embodiment, the lugs 44 are designed as rigid elements on the receiving clamp 1, preferably each arranged on one of the receiving elements 13, and they each comprise an opening 60. A pivot axis 69, illustrated in FIG. 4 and in FIG. 9, is extending through the lugs 44. The pivot axis 69 is advantageously the center axis of the openings 60 of the two lugs 44. The power tool 2 suspended from the carrying system 3 is pivotable about the pivot axis 69. In the plan view illustrated in FIG. 9, the pivot axis 69 is positioned perpendicular to the longitudinal center axis 7; the pivot axis 69 does not intercept the longitudinal center axis 7 at any point. In this way, the power tool 2 with its guide rod 18 can be oriented in a force-saving way at different angles relative to the ground.

In the embodiment, the actuating device 16 is comprised of two projections 38 (FIGS. 4 through 7) that are arranged opposite each other relative to the vertical plane 50 on a respective receiving element 13. As illustrated in FIG. 6, the projections 38 are formed monolithically or as one piece together with the receiving elements 13, respectively, and designed as arc-shaped grips. The projections 38 project away from the receptacle 5 in the direction of the side of the plane 49 facing away from the slot 6. In order to avoid that the hand of an operator 21 can slip off the projections 38, profiles 41 are preferably provided on the actuating sides 54 of the projections 38 which are oriented away from the vertical plane 50. The profiles 41 are preferably in the form of a plurality of knobs or semi-circular raised portions.

As shown in FIG. 5 and FIG. 6, a respective groove 45 is arranged on the exterior side 53 of the receiving clamp 1 adjacent to each end face 10, 11 and is extending in circumferential direction in the embodiment. A spring element 14 is arranged in each groove 45. The groove 45 extends across both receiving elements 13 so that the spring element 14 is axially secured in the groove 45 in both receiving elements 13. The width a of the groove 45 amounts preferably to at least 5 mm. The ends of the groove 45, approximately positioned in circumferential direction, are provided with a respective securing nipple 47. The spring element 14 comprise at each end an opening 46 into which a securing nipple 47 is projecting for form-fit fixation of the spring element 14. The spring elements 14 are arc-shaped and in cross section of a flat configuration; they are comprised advantageously of spring steel.

The suspending locations 20, as shown in FIG. 6, are arranged in the upper half of the receiving clamp 1, i.e., in the embodiment above the horizontal plane 49. The suspending locations 20 in the embodiment comprise a spacing k relative to the second plane or to the horizontal plane 49. As shown in FIG. 17, the spring elements 14 have a spacing h relative to the suspending locations 20 that is measured parallel to the longitudinal axis 7. In this way, the spacing m measured in the direction of the longitudinal center axis 7 between the two spring elements 14 results. The spacing h amounts advantageously to an amount of at least 0.5 times the smallest inner diameter d_{I}. The spacing m amounts advantageously to at least 60%, in particular at least 80%, of the length I of the receiving clamp 1 illustrated in FIG. 9. The spring elements 14 are arranged at minimal spacing relative to the end faces 10 and 11. The spacing e of a spring element 14 relative to the neighboring end face 10 or 11 (FIG. 6) is advantageously smaller than 0.2 times, in particular 0.1 times, the amount of the smallest inner diameter d_{I}.

When the power tool 2 is mounted with a location that is away from its center of gravity at the receiving clamp 1, a tilting moment is caused which tilts the longitudinal axis of the guide rod 18 relative to the longitudinal center axis 7 of the receptacle 5 so that the guide rod 18 is pushed diagonally out of the receptacle 5. In order to prevent that the power tool 2 accidentally drops due to its weight out of the receptacle 5 as a result of the force of gravity, it is provided to compensate the tilting moment as well as the opening moment up to a certain amount. Advantageously, the tilting moment and the opening moment are compensated by means of one and the same at least one spring element 14. A strong spring element 14 prevents the guide rod 18 from tilting or falling out of the receiving clamp 1 when the operator 21 allows the power tool 2 to “drop” into the carrying system 3. At the same time, however, the release force F_{A} (FIG. 2) required for the emergency release is increased. In order to avoid tilting of the guide rod 18 out of the receiving clamp 1 and to achieve at the same time a comparatively minimal release force F_{A} for opening the receiving clamp 1, the spacing h (FIG. 17) of the spring elements 14 relative to the suspending location 20 is provided. Due to the comparatively large spacing k of the spring elements 14 relative to the suspending location 20, a great lever arm is provided so that the spring elements 14 can be selected to be relatively weak in order to compensate the tilting moment. At the same time, in this way it is ensured that the release force F_{A} required for an emergency release can be applied without problem by an operator 21.

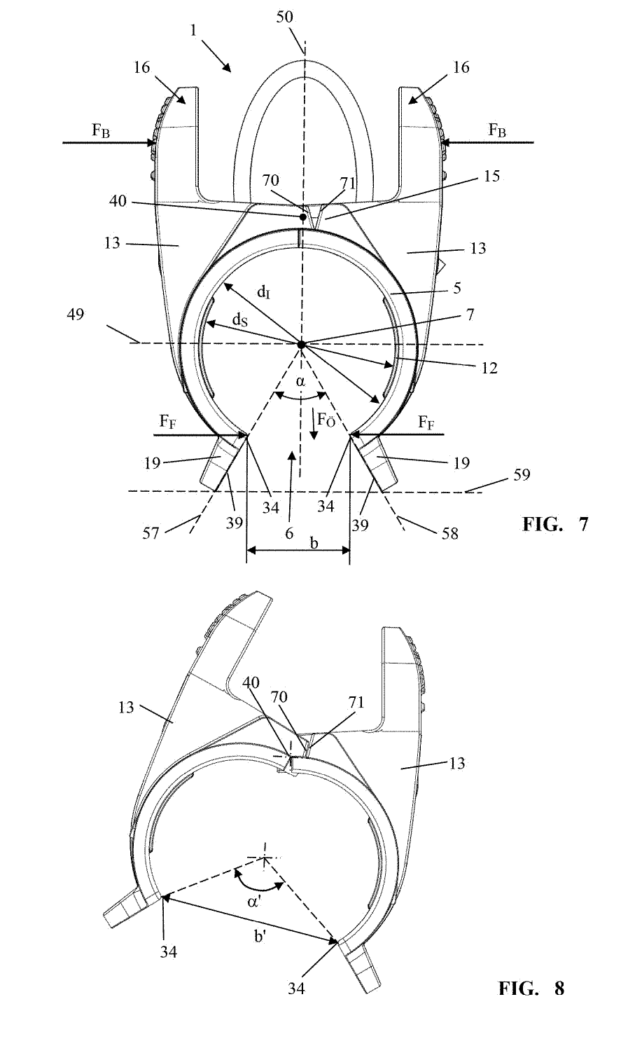

FIG. 7 shows a front view of the receiving clamp 1. The substantially cylindrical circumferential wall of the receptacle 5 comprises in circumferential direction two edges 34 which, in the state of the receiving clamp 1 suspended from the suspending locations 20, are positioned opposite each other relative to the vertical plane 50 and delimit between them the slot 6. The spacing of the two edges 34 relative to each other corresponds to the width b of the slot 6. The width b of the slot 6 is constant in the embodiment. The slot 6 extends advantageously parallel to the longitudinal center axis 7. Advantageously, the width b of the slot 6 amounts to at least 25% and at most 80% of the inner diameter d_{I} and of the free inner diameter dₛ. The width b of the slot 6 is smaller than the smallest outer diameter d of the guide rod 18 illustrated in FIG. 19. The width b of the slot 6 amounts advantageously to at least 0.25 times, in particular at least 0.3 times, preferably at least 0.4 times, the inner diameter d_{I} of the receptacle 5. The width b of the slot 6 amounts advantageously to at most 0.8 times, in particular at most 0.7 times, preferably at most 0.6 times, the inner diameter d_{I} of the receptacle 5. In the embodiment, a width b is provided which amounts to 0.45 times to 0.6 times the inner diameter d_{I}. The inner diameter d_{I} of the receptacle 5 amounts advantageously to at least 20 mm, in particular at least 30 mm, preferably at least 40 mm. The free inner diameter dₛ measured between the clamping ribs 12 amounts preferably to at least 35 mm. In the clamped state in which the receiving clamp 1 is secured by clamping action on the guide rod 18, the inner diameter d_{I} and the free inner diameter dₛ of the receptacle 5 are advantageously greater than the width b of the slot 6. In the clamped state, the free inner diameter dₛ corresponds advantageously to the diameter of the guide rod 18. All specified measures and ratios relate to the non-actuated state of the receiving clamp 1 in which the receptacle 5 is empty, i.e., no guide rod 18 is arranged in the receptacle 5. In the release state in which the receiving clamp 1 is being released from the guide rod 18, the width b of the slot 6 in at least one position is at least as large as the free inner diameter dₛ.

The receiving clamp 1 is designed to have bending elasticity in transverse direction relative to the length direction of the slot 6. The bending elasticity of the receiving clamp 1 causes a spring force F_{F} which counteracts widening of the slot 6. For widening the slot 6, an opening force F_{O} (FIG. 7) must be exerted which is oriented from the suspending location 20 in the direction toward the slot 6. The opening force F_{O} is in particular applied as a release force F_{A} (FIG. 2) at the guide rod 18, for example, by the operator 21 or by cut material that is dropping onto the guide rod, for example, a branch or the like. In usual working position, the force caused by the weight of the power tool 2 is oriented in the direction of the slot 6 of the receptacle 5. The weight of the power tool 2 therefore also contributes to the release force F_{A}. The release force F_{A} on the guide rod 18 is advantageously applied suddenly or as a jerky movement and effects that the guide rod 18 exerts on the receiving clamp 1 an opening force F_{O} onto the edges 34 of the receptacle 5 which effects in turn a force on the receiving elements 31 counteracting the spring force F_{F}. By means of the release force F_{A} which is acting on the guide rod 18 at least partially in the direction of the force of gravity, the slot 6 can be widened so far that the guide rod 18 can be removed through slot 6 from the receiving clamp 1. The opening force F_{O} required for opening the receiving clamp 1 amounts advantageously to at least 1.5 times the force of the weight of the power tool 2, in particular at least two times, preferably at least three times, the force of the weight of the power tool 2. The opening force F_{O} amounts advantageously to at least 200 N, in particular at least 400 N. In this way, it is ensured that the power tool 2 in usual operation is secured safely in the receiving clamp 1 and that the receiving clamp 1 does not open solely due to the force of the weight of the power tool 2 acting on the edges 34 of the receiving clamp 1. It is also ensured that in particular in case of sudden strong loads acting on the power tool the receiving clamp 1 does not open and the guide rod 18 does not slip out of the receiving clamp 1.

In an arrangement in which the power tool 2 is secured by the receiving clamp 1 on the carrying system 3, the guide bar 18 is secured in the receiving clamp 1 by a clamping action with the spring force F_{F}. In this context, the clamping ribs 12 of the receptacle 5 are clamped by the spring force F_{F} against the exterior surface 53 of the guide rod 18 so that the guide rod 18 is axially fixed in the receiving clamp 1. The guide rod 18 is secured in the receiving clamp 1 in axial direction in particular exclusively by friction and in radial direction by friction and form fit.

Removing the guide rod 18 from the receiving clamp 1 can be realized, on the one hand, by actuation of the actuating device 16 or, on the other hand, by simply pushing away the guide rod 18 from the carrying system 3. In the latter case, no separate actuating device 16 must be actuated and the hands of the operator 21 can stay on the guide rod 18 or a grip 37. The operator 21 must only push the guide rod 18 away from himself or from the carrying system 3. Pushing the guide rod 18 away is intuitive and requires no re-positioning of the hands by the operator 21. A weight which is dropping onto the guide rod 18, for example, a thick branch, automatically results in an emergency release due to the caused impulse on the guide rod 18, without the operator 21 having to become active.

The receiving clamp 1 is easily detachable from the power tool 2 so that the carrying system 3 with the receiving clamp 1 can be fixed in a simple way on different kinds of power tools 2 without this requiring complex retrofitting of the receiving clamp 1. The release of the receiving clamp 1 from the guide rod 18 is simple and intuitive. Since no actuating elements, such as actuating device 16, must be actuated, a release of the power tool 2 from the receiving clamp 1—even when wearing gloves—is possible in a simple way. A simple release of the power tool 2 from the receiving clamp 1 is in particular advantageous when for holding the power tool 2 both hands are used, for example, in order to balance the power tool 2. For release of the power tool 2 from the receiving clamp 1, both hands of the operator 21 can stay on the power tool 2.

The connecting element 29 can transmit exclusively tensile forces from the receiving clamp 1 onto the carrying system 3. When pushing away the guide rod 18 from the carrying system 3 with a release force F_{A}, first the connecting element 29 is tensioned so that the carrying system 3 subsequently can serve as an abutment. A continuing release force F_{A} effects then an opening moment about the joints 15 counteracted by the closing force of the spring elements 14, i.e., the spring force F_{F}. From a defined release force F_{A} on, the spring force F_{F} is overcome and the receiving elements 13 pivot to the side so that the guide rod 18 can fall downward through the widened slot 6.

The widened spread-apart slot 6 is illustrated in FIG. 8. The two receiving elements 13 in the spread-apart state illustrated in FIG. 8 of the receiving clamp 1 are pivoted relative to each other about joint axis 40. The edges 34 are positioned at an angle α′ about the longitudinal center axis 7 that is greater than the angle α in the non-actuated state (FIG. 7). The slot 6 has a width b′ which corresponds at least to the greatest diameter d of the guide rod 18 (FIG. 19).

When opening the receiving clamp 1, the lever arm between actuating device 16 and joint axis 40 is acting when actuating the actuating device 16 for opening the receiving clamp 1. When opening the receiving clamp 1 by applying a release force F_{A} on the guide rod 18, the lever arm acts between the edges 34 of the receptacle 5 and the joint axis 40. Manual actuation of the actuating device 16 by the operator 21 with an actuating force F_{B} on the actuating device 16 has the effect that the receiving elements 13 are pivoted about joint axis 40. The actuating force F_{B} is counteracted by the spring force F_{F}. When the moment that is resulting from the actuating force F_{B} about joint axis 40 is greater than the moment which is resulting from the spring force F_{F}, the spring force F_{F} is overcome and the slot 6 of the receptacle 5 is widened. When the guide rod 18 is secured in the receiving clamp 1 and the spring force F_{F} is overcome by the actuating force F_{B} at least partially, the guide rod 18 can be displaced within the receptacle 5 and can be aligned accordingly to the working position in operation, as needed.

As shown in FIG. 7, the insertion elements 19 provided at the receptacle 5 have inner sides 39 which are facing the vertical plane 50. The inner sides 39 are positioned in two planes 57 and 58 which define an opening angle α in a viewing direction parallel to the longitudinal center axis 7. The opening angle α in the non-actuated state of the receiving clamp 1 amounts to preferably 20° to 120°, in particular 40° to 100°, preferably approximately 60°. The opening angle α corresponds to the angle that the edges 34 define together with the longitudinal axis 7. Due to the opening angle α of the insertion elements 19 mounting of the receptacle 5 and of the guide rod 18 can be realized by placing the receptacle 5 on the guide rod 18 and subsequently applying pressure on the receptacle 5. In a state of the receiving clamp 1 placed onto a horizontal flat support surface 59, the angle between the inner sides 39 of the insertion elements 19 and the horizontal flat support surface 59, pointing toward the horizontal plane 49, is preferably less than 80°. The receiving elements 13 have advantageously a stop, illustrated in FIG. 7, which is formed by stop elements 70 and 71 on the receiving elements 13. The stop delimits an opening movement of the receiving clamp 1 so that damage of the receiving clamp 1 by overextending it is avoided. In FIG. 7 and FIG. 9, the stop elements 70 and 71 are illustrated in the non-actuated state of the receiving clamp 1 at a spacing relative to each other. In FIG. 8 and FIG. 10, the receiving clamp 1 is opened maximally and the stop elements 70 and 71 are contacting each other.

FIG. 9 shows the plan view of the receiving clamp 1. The length l of the receiving clamp 1 corresponds to the maximum spacing between the first end face 10 and the second end face 11 measured parallel to the longitudinal center axis 7. The length l corresponds thus to the length of the receptacle 5. In the embodiment, the insertion elements 19 (FIG. 4) extend almost across the entire length l of receptacle 5 or receiving clamp 1 from one end face 10 to the other end face 11. Preferably, the length l of the receiving clamp 1 amounts to at least 50 mm, in particular 80 mm. The length l of the receiving clamp 1 is greater than the inner diameter d_{I}, and the free inner diameter dₛ of the receptacle 5 (FIG. 7). The ratio of length l to the inner diameter d_{I} and to the free inner diameter d_{S} is preferably greater than 1, in particular greater than 1.5.

In FIG. 11, an illustration of the receiving clamp 1 in a view from below is shown. On the insertion elements 19 of the receiving clamp 1, a support edge 17 for placing the receiving clamp 1 onto a support surface is arranged, respectively. The slot 6 has across its entire length from the end face 10 to the end face 11 a minimum width which in the embodiment corresponds to the width b. In the embodiment, the width b of the slot 6 is constant across the entire length l (FIG. 7) of the receiving clamp 1. In the embodiment, the support edges 17 and insertion elements 19 extend at a spacing and parallel to the longitudinal center axis 7. The receiving elements 13 which are facing each other are preferably congruently configured so that the manufacture is simplified.

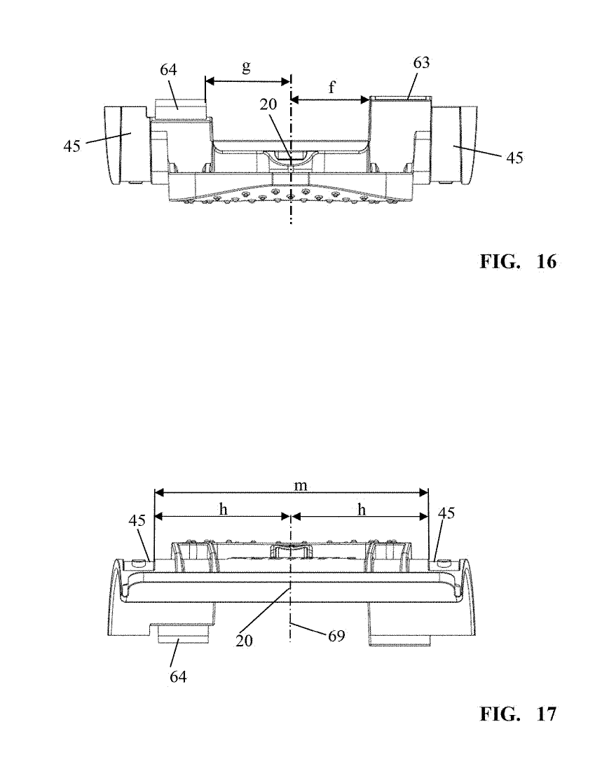

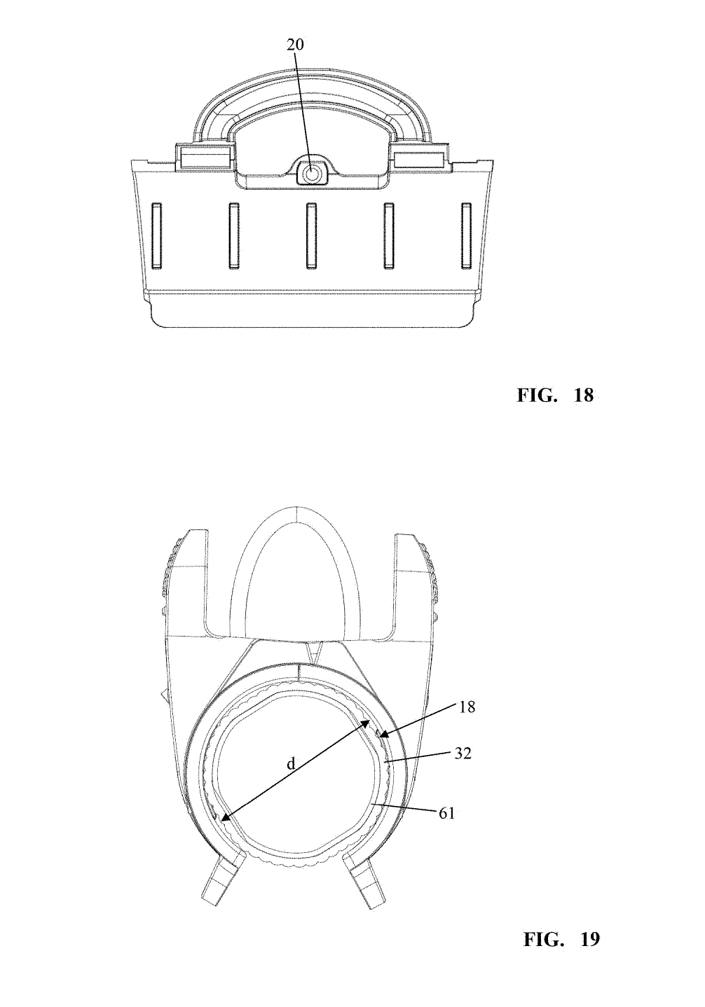

The configuration of the joints 15 is illustrated in detail in FIGS. 12 to 18. FIGS. 12 to 18 show in this context one of the receiving elements 13. In the embodiment, both receiving elements 13 are of identical configuration. On one side of the receiving element 13, a joint socket 63 is formed that is part of a first joint 15. The joint socket 63 comprises a bottom 66 which is curved parallel to the joint axis 40. On the opposite side of the receiving element 13, a joint head 64 is arranged whose end face 65 is curved. The curvature of the end face 65 extends also parallel to the joint axis 40. The end face 65 and the bottom 66 in cross section are advantageously approximately curved in a circular arc shape about the joint axis 40. The rim of the joint socket 63 engages about the joint head 64 so that the joint 15 is protected from becoming soiled. The joint socket 63 is arranged at a spacing f relative to the suspending location 20 which is measured parallel to the longitudinal center axis 7 and is slightly greater than the spacing g of the joint head 64 relative to the suspending location 20, as shown in FIG. 16. The grooves 45 for receiving the spring elements 14 are father removed from the suspending location 20. The grooves 45 or the spring elements 14 are positioned relative to the suspending location 20 at a spacing h, respectively, which is illustrated in FIG. 17 and which is greater than the spacings f and g.

The specification incorporates by reference the entire disclosure of German priority document 10 2016 013 145.4 having a filing date of Oct. 31, 2016.

While specific embodiments of the invention have been shown and described in detail to illustrate the inventive principles, it will be understood that the invention may be embodied otherwise without departing from such principles.

What is claimed is:

1. A receiving clamp for a power tool, the receiving clamp comprising:
a clamp body comprising a first end face and a second end face and a receptacle extending from the first end face to the second end face and configured to receive a guide rod of a power tool;
wherein the receptacle comprises a longitudinal center axis and further comprises a slot extending from the first end face to the second end face;
wherein the slot is open relative to an environment across an entire length of the slot from the first end face to the second end face;
wherein the clamp body comprises a bending elasticity in a direction transverse to a length direction of the slot so that the slot can be widened;
at least one suspending location arranged on the clamp body and configured to connect to a carrying system for the power tool;
wherein the at least one suspending location is arranged such that, when the receiving clamp is suspended by the at least one suspending location and the longitudinal center axis is positioned in a horizontal plane, the slot is located lower than the at least one suspending location.

2. The receiving clamp according to claim 1, wherein the bending elasticity counteracts widening of the slot.

3. The receiving clamp according to claim 1, further comprising insertion elements configured to thread a guide of the power tool into the receptacle, wherein the insertion elements are arranged so as to extend at least partially along the slot.

4. The receiving clamp according to claim 3, wherein the insertion elements each have a support edge extending parallel to the longitudinal center axis and configured to support the receiving clamp on a support surface.

5. The receiving clamp according to claim 1, wherein the receptacle has a length measured parallel to the longitudinal center axis and has a smallest inner diameter measured perpendicular to the longitudinal center axis, wherein the length is greater than the smallest inner diameter.

6. The receiving clamp according to claim 1, further comprising clamping ribs arranged on an inner surface of the receptacle and extending in a circumferential direction of the receptacle.

7. The receiving clamp according to claim 1, wherein the clamp body comprises two rigid receiving elements and at least one spring element.

8. The receiving clamp according to claim 7, wherein the two receiving elements are connected by a joint to each other.

9. The receiving clamp according to claim 7, wherein the two receiving elements are braced relative to each other by the at least one spring element.

10. The receiving clamp according to claim 7, wherein the at least one spring element extends about a wrap angle of at least 200° measured about the longitudinal center axis.

11. The receiving clamp according to claim 7, wherein the receptacle has a smallest inner diameter measured perpendicular to the longitudinal center axis, wherein a spacing of the at least one spring element measured in a direction of the longitudinal center axis relative to the at least one suspending location is at least 0.5 times the smallest inner diameter.

12. An arrangement comprising:
a carrying system for a power tool;
a receiving clamp comprising a clamp body comprising a first end face and a second end face and a receptacle extending from the first end face to the second end face, wherein the receptacle comprises a longitudinal center axis and further comprises a slot extending from the first end face to the second end face, wherein the slot is open relative to the environment across an entire length of the slot from the first end face to the second end face, wherein the clamp body comprises a bending elasticity in a direction transverse to a length direction of the slot so that the slot can be widened, wherein at least one suspending location is arranged on the clamp body and configured to connect to the carrying system, wherein the at least one suspending location is arranged such that, when the receiving clamp is suspended by the at least one suspending location and the longitudinal center axis is positioned in a horizontal plane, the slot is located lower than the at least one suspending location;
wherein the carrying system comprises a support arm and the receiving clamp is arranged on the support arm;
wherein the receiving clamp is held by the at least one suspending location on the carrying system, wherein the slot is at least partially facing downwardly in an operating position of the carrying system, wherein in the operating position the receiving clamp is suspended from the carrying system.

13. An arrangement comprising:
a power tool comprising a guide rod;
a carrying system configured to carry the power tool;
a receiving clamp comprising a clamp body comprising a first end face and a second end face and a receptacle extending from the first end face to the second end face, wherein the receptacle comprises a longitudinal center axis and further comprises a slot extending from the first end face to the second end face, wherein the slot is open relative to the environment across an entire length of the slot from the first end face to the second end face, wherein the clamp body comprises a bending elasticity in a direction transverse to a length direction of the slot so that the slot can be widened, wherein at least one suspending location is arranged on the clamp body and configured to connect to the carrying system, wherein the at least one suspending location is arranged such that, when the receiving clamp is suspended by the at least one suspending location and the longitudinal center axis is positioned in a horizontal plane, the slot is located lower than the at least one suspending location;
wherein the guide rod of the power tool is secured in the receptacle;
wherein the slot is at least partially facing downwardly in an operating position of the guide rod, wherein in the operating position the power tool is suspended from the carrying system and secured by the receiving clamp on the carrying system.

14. The arrangement according to claim 13, wherein the guide rod is clamped in the receiving clamp by a spring force.

15. The arrangement according to claim 14, wherein the receiving clamp comprises an actuating device, wherein by actuating the actuating device the spring force is at least partially canceled and the guide rod of the power tool is slidable in the direction of the longitudinal center axis in the receiving clamp.

16. The arrangement according to claim 13, wherein the bending elasticity of the receiving clamp counteracts widening of the slot and wherein widening the slot requires an opening force in a direction from the at least one suspending location toward the slot of at least 1.5 times a weight force of the power tool.

17. The arrangement according to claim 16, wherein the slot is configured to be widened by a release force acting on the guide rod at least partially in a direction of the force of gravity such that the guide rod is removable through the slot from the receiving clamp by the release force.
